(19) United States
(12) Patent Application Publication
(10) Pub. No.: US 2026/0177207 A1
(43) Pub. Date: Jun. 25, 2026

(54) High Pressure Tank Connection System and a Valve Assembly Thereof

(71) Applicants: Hyundai Motor Company, Seoul (KR); Kia Corporation, Seoul (KR); HWAYOUNG CO., LTD., Busan (KR); DONG HEE INDUSTRIAL CO., LTD., Ulsan (KR)

(72) Inventors: Seon Woo Boo, Hwaseong-Si (KR); Sung Won Lee, Hwaseong-Si (KR); Seong Cheol Cho, Hwaseong-Si (KR); Seung Jun Lee, Busan (KR); Su Jin An, Gimhae-si (KR); Kun Su Hwang, Incheon (KR); Kyun Bum Park, Hwaseong-Si (KR)

(21) Appl. No.: 19/256,803

(22) Filed: Jul. 1, 2025

(30) Foreign Application Priority Data
Dec. 20, 2024 (KR) 10-2024-0193020

(51) Int. Cl. F17C 13/04; F17C 13/08; G05D 16/10

(52) U.S. Cl. CPC F17C 13/04; F17C 13/08; G05D 16/10; F17C 2205/0332; F17C 2205/0338; F17C 2221/012

(57) ABSTRACT

A high pressure tank connection system including a plurality of high pressure tanks each including a nozzle part, from which a hydrogen fuel is discharged, a container fixing block connected to the nozzle part, and including a gas passage part, in which the hydrogen fuel discharged from the nozzle part flows, in an interior space thereof, and a valve assembly connected to the gas passage part of the container fixing block, and including an internal fluid path, to which a plurality of valves are connected, in an interior thereof.

### CROSS-REFERENCE TO RELATED APPLICATION

This application claims the benefit of priority to Korean Patent Application No. 10-2024-0193020, filed in the Korean Intellectual Property Office on Dec. 20, 2024, the entire contents of which are incorporated herein by reference.

### TECHNICAL FIELD

The present disclosure relates to a valve system for a high pressure tank mounted on a hydrogen-powered vehicle.

### BACKGROUND

Some vehicles (e.g., hybrid vehicles, electric vehicles, and/or hydrogen-powered vehicles, called eco-friendly vehicles) are equipped with high-voltage batteries that apply electric power to a driving motor.

Hydrogen-powered vehicles are equipped with a fuel battery system that is configured to charge a high-voltage battery with electric power.

The hydrogen-powered vehicles generate their own electricity through a chemical reaction between hydrogen and oxygen. This generated electricity is used to drive motors. The hydrogen-powered vehicles may include a high pressure tank that stores high-pressure hydrogen gas, an air compressor that supplies air, and a fuel cell stack that generates electric energy through an electrochemical reaction between the hydrogen gas and the air.

The hydrogen gas is discharged from the high pressure tank to a high-pressure line according to an operation of a solenoid valve mounted at an inlet of the high pressure tank. The discharged hydrogen gas is then decompressed by the regulator and supplied to the fuel cell stack.

The valve system of a hydrogen-powered vehicle may include a valve assembly for controlling filling and supply of hydrogen to a filling line for filling hydrogen in the high pressure tank and/or to a supply line for supplying the hydrogen from the high pressure to a stack, separately.

At least some valve system has a function of adjusting filled and supplied hydrogen, a function of preventing reverse flow of hydrogen while blocking the filling and supply lines and/or adjusting a pressure of the hydrogen, and/or a function of manually blocking the filled and supplied hydrogen.

However, according to the valve system, due to expansion, hydrogen that is compressed to a high pressure is leaked as the airtightness of connection parts of the valves of the valve system deteriorates. For example, an O-ring or a rubber member, such as silicon, of the valve system may fail to exhibit a sufficient airtightness at connection parts of the valves.

In addition, because a number of pipes, manifolds, receptacles, and regulators may be connected to the high pressure tank, there may be a problem such as an increase in the weight and the installation space of parts, and/or an increase in costs. There is a need for a solution to the above and other problems related to a valve system for a hydrogen-powered vehicle.

The matters described in this Background section are only for enhancement of understanding of the background of the disclosure, and should not be taken as acknowledgement that they correspond to prior art already known to those skilled in the art.

### SUMMARY

The following summary presents a simplified summary of certain features. The summary is not an extensive overview and is not intended to identify key or critical elements.

Systems, apparatuses, and methods are described for a valve unit of a high pressure tank. A valve assembly may comprise: a hydrogen fuel inlet; a hydrogen fuel outlet; a solenoid valve configured to control flow of a hydrogen fuel, supplied from or filled to a plurality of high pressure tanks, through the hydrogen fuel inlet or the hydrogen fuel outlet; a first pressure relief valve configured to release a pressure based on the hydrogen fuel satisfying one or more of: a high-temperature limit; or a high-pressure upper limit; a regulator configured to regulate a pressure of the hydrogen fuel being supplied from the plurality of high pressure tanks; and a first valve housing comprising a second pressure relief valve configured to release a pressure when a pressure of an outlet of the regulator is higher than a target pressure, wherein the valve assembly forms an internal fluid path between the hydrogen fuel inlet and the hydrogen fuel outlet.

A high pressure tank connection system comprising: a plurality of high pressure tanks, each comprising a nozzle configured to discharge a hydrogen fuel; a container fixing block configured to accommodate the plurality of high pressure tanks and comprising a gas passage, in which the hydrogen fuel discharged from the nozzle flows, in an interior space thereof; and a valve assembly, connected to the gas passage, forming an internal fluid path, and comprising a plurality of valves configured to control a flow of hydrogen fuel through the internal fluid path. The valve assembly may be as described herein.

These and other features and advantages are described in greater detail below.

### BRIEF DESCRIPTION OF THE DRAWINGS

The above and other objects, features and advantages of the present disclosure will be more apparent from the following detailed description taken in conjunction with the accompanying drawings:

FIG. 1 is a perspective view illustrating a high pressure tank connection system, to which a valve unit of a high pressure tank according to an example of the present disclosure is applied;

FIG. 2 is a perspective view illustrating main components of a valve unit of a high pressure tank according to an example of the present disclosure;

FIG. 3 is an exploded perspective view illustrating main components of a valve unit of a high pressure tank according to an example of the present disclosure;

FIG. 4 is a circuit diagram illustrating an operation and control of a valve unit of a high pressure tank according to an example of the present disclosure;

FIG. 5 is a cross-sectional view illustrating a regulator of a valve unit of a high pressure tank according to an example of the present disclosure; and

FIG. 6 is a graph depicting flow rates according to a diameter of a passage of a regulator according to an example of the present disclosure.

### DETAILED DESCRIPTION

Hereinafter, some examples of the present disclosure will be described in detail with reference to the accompanying drawings. In adding reference numerals to the components of the drawings, the same components have the same numerals, where possible, across different drawings. In describing examples of the present disclosure, detailed descriptions associated with well-known functions or configurations will be omitted if such detailed descriptions would obscure the subject matters of the present disclosure.

Furthermore, in describing components of examples of the present disclosure, the terms first, second, A, B, (a), (b), and the like may be used herein. These terms are only used to distinguish one component from another component, but do not limit the corresponding components irrespective of the nature, order, or priority of the corresponding components. When it is described that a certain component is “connected to”, “coupled to” and/or “electrically connected to”, etc., a second component, it should be understood that the component may be directly connected, directly coupled, and/or directly electrically connected to the second component, or a third component may be “connected”, “coupled” or “electrically connected” between the certain component and the second component, unless “directly” is explicitly stated.

For purposes of this application and the claims, using the exemplary phrase “at least one of: A; B; or C” or “at least one of A, B, or C,” the phrase means “at least one A, or at least one B, or at least one C, or any combination of at least one A, at least one B, and at least one C. Further, exemplary phrases, such as “A, B, or C”, “at least one of A, B, and C”, “at least one of A, B, or C”, etc. as used herein may mean each listed item or all possible combinations of the listed items. For example, “at least one of A or B” may refer to (1) at least one A; (2) at least one B; or (3) at least one A and at least one B. “One or more of” is synonymous with “at least one of” herein.

Unless otherwise defined, the terms used herein, including technical or scientific terms, may have meanings generally understood by those skilled in the art to which the present disclosure belongs.

The expressions such as “comprise”, “may comprise”, “include”, “may include”, “have”, “may have”, etc. as used herein are intended to mean the presence of a characteristic (e.g., function, operation, component, etc.) and do not exclude the presence of other additional characteristics. That is, these expressions should be understood as open-ended terms that encompass the possibility that other examples are included.

A singular expression used herein may include the meaning of the plural unless otherwise stated in the context, which also applies to the singular expression described in the claims.

The expression “based on” as used herein is intended to describe one or more factors that influence an act or operation of determining or deciding described in a phrase or sentence including that expression, and this expression does not exclude any additional factors that influence the act or operation of determining or deciding.

Depending on the context, the expression “configured to” as used herein may have meanings such as “set to”, “with the ability to”, “modified to”, “made to”, “to be able to”, etc. This expression is not limited to the meaning of “specially designed in hardware to”. For example, a processor configured to perform a specific operation may refer to a generic purpose processor capable of performing the specific operation by executing software, or to a special purpose computer structured through programming to perform the specific operation.

The term “about” in relation to a reference numerical value, and its grammatical equivalents as used herein, can include the reference numerical value itself and a range of values plus or minus 10% from that reference numerical value. For example, the term “about 10” includes 10 and any amount from and including 9 to 11. In some cases, the term “about” in relation to a reference numerical value can also include a range of values plus or minus 10%, 9%, 8%, 7%, 6%, 5%, 4%, 3%, 2%, or 1% from that reference numerical value. In some embodiments, “about” in connection with a number or range measured by a particular method indicates that the given numerical value includes values determined by the variability of that method.

Hereinafter, a valve unit of a high pressure tank according to an example of the present disclosure will be described in detail with reference to the accompanying drawings.

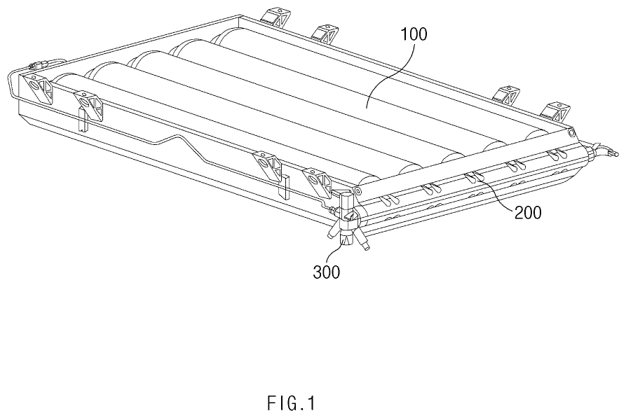

FIG. 1 is a perspective view illustrating a high pressure tank connection system, to which a valve unit of a high pressure tank according to an example of the present disclosure is applied.

As illustrated in FIG. 1, a high pressure tank connection system according to an example of the present disclosure may include one or more high pressure tanks 100 (e.g., a plurality of high pressure tanks 100 shown in FIG. 1). Each high pressure tank may store a high-pressure hydrogen fuel. The high pressure tank connection system may include a container fixing block 200 that is connected to one or more outlets of the one or more high pressure tanks 100. The high pressure tank connection system may include a valve assembly 300 that is connected via a gas passage part (e.g., a gas passage) of the container fixing block 200. The valve assembly 300 may performs a function of controlling filling the one or more high pressure tanks 100, supplying hydrogen from the one or more high pressure tanks 100, and/or blocking the hydrogen gas (e.g., from flowing into or out of the one or more high pressure tanks 100). The valve assembly 300 may perform a safety function in the case of a rise in temperature and/or loss of a valve function.

The container fixing block 200 may accommodate a nozzle part (e.g., nozzle) of the one or more high pressure tanks 100. For example, the container fixing block 200 may include the gas passage part (e.g., in an internal space of the container fixing block 200), through which the gas discharged from the one or more nozzle parts may be configured to flows.

The container fixing block 200 may be formed to have a length configured (e.g., sufficient) to accommodate the one or more nozzle parts of the one or more high pressure tanks 100. For example, the container fixing block 200 may have a length sufficient to accommodate a plurality of nozzle parts of a plurality of high pressure tanks 100, such that every nozzle part of the plurality of nozzle part is able to exchange hydrogen gas with the single gas passage part.

The gas passage part may be formed in a lengthwise direction of the container fixing block 200, and/or may guide a flow of gas discharged from the one or more nozzle parts.

The hydrogen fuel stored in the high pressure tank 100 may be compressed at a high pressure and stored in the high pressure tank 100. The hydrogen fuel may be provided to a fuel cell stack to react with oxygen to cause a reverse reaction to an electrolysis reaction so as to generate electric current and act as a power source for a motor.

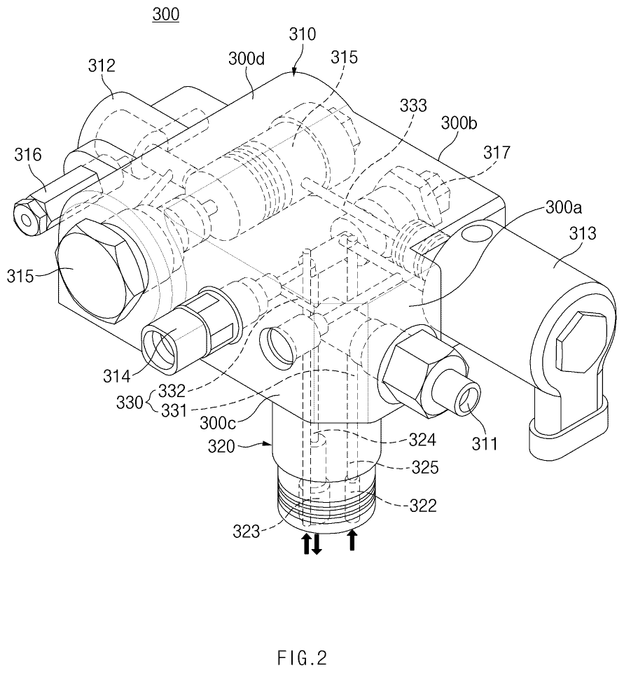

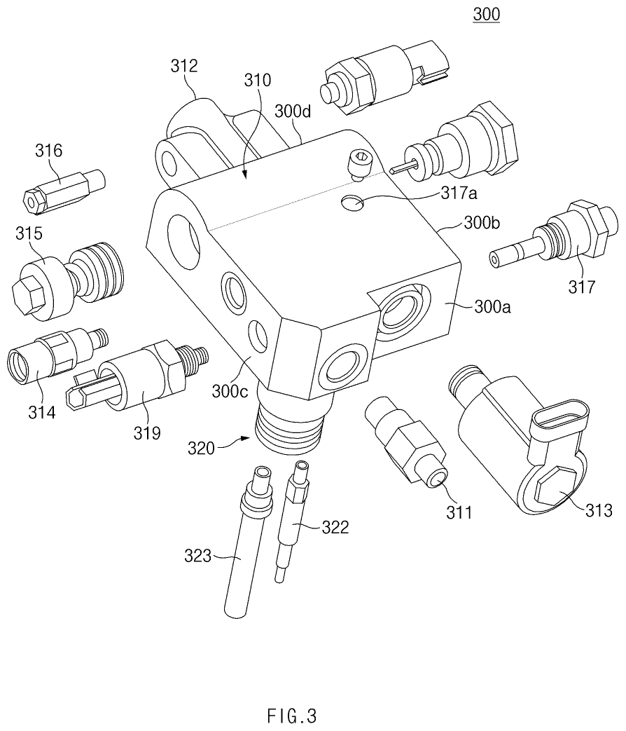

FIG. 2 is a perspective view illustrating main components of a valve unit (also referred to herein as a valve assembly) of a high pressure tank connection system according to an example of the present disclosure, and FIG. 3 is an exploded perspective view illustrating main components of a valve unit of a high pressure tank connection system according to an example of the present disclosure.

As illustrated in FIGS. 2 and 3, the valve unit/assembly 300 may include a first valve housing part 310 (e.g., a first valve housing, a first part of a valve housing of the valve assembly) that may be provided with a plurality of valves and a plurality of internal fluid paths (e.g., tubes, pipes, passages), and a second valve housing part 320 (e.g., a second valve housing) that may be mounted on the high pressure tank 100.

### First Valve Housing Part

The first valve housing part 310 may include a hydrogen inlet 311, a hydrogen outlet 312, a solenoid valve 313 (e.g., that controls supply and/or blocking of the hydrogen fuel), a temperature-sensitive pressure relief valve (TPRD; first pressure relief valve) 314 (e.g., that releases a pressure when the hydrogen fuel satisfies a criteria, such as reaches a high-temperature and/or high-pressure upper limit), a regulator 315 (e.g., that regulates the hydrogen fuel supplied from the high pressure tank 100 to an appropriate pressure), and a pressure relief valve (PRV) 316 (e.g., that releases a pressure when a pressure of an outlet of the regulator 315 satisfies a target pressure, such as being higher than or equal to or higher than the target pressure).

the first valve housing may include an integrated valve 317 that includes a manual valve (e.g., configured to be manually and/or automatically operated when/if a blocking function of the solenoid valve 313 is lost/stops working/fails) integrated with a bleed valve (e.g., configured to be manually and/or automatically operated when/if an unblocking function of the solenoid valve 313 is lost/stops working/fails).

As an example, the hydrogen inlet 311 may be connected to a filling passage (e.g., pipe, tube, etc.) configured to allow filling of the one or more high pressure tanks 100 with hydrogen fuel. A check valve 311a may be installed in a common passage of the hydrogen inlet 311 and an integrated passage 321. A filter 318 may be provided on a rear side of the check valve 311a (e.g., behind the check valve 311a relative to an entrance of the hydrogen inlet 311. The filter 318 may prevent introduction of foreign substances when the hydrogen fuel is filled to the one or more high pressure tanks 100.

The hydrogen outlet 312 may be connected to an outlet port (not illustrated) of the regulator 315.

The solenoid valve 313 may be/comprise a valve that controls a flow of the fuel between the one or more high pressure tanks 100 and the fuel cell stack (e.g., to supply hydrogen fuel to the fuel cell stack and/or block the hydrogen fuel from flowing between the high pressure tank 100 and the fuel cell stack). The solenoid valve 313 may control the flow in response to an electrical signal from a controller (e.g., a control device; not illustrated). The solenoid valve 313 may regulate the flow of the filled and/or supplied fuel (hydrogen) and/or may control a pressure of the hydrogen (e.g., in the one or more hydrogen pressure tanks, as supplied to the fuel cell). The solenoid valve 313 may operate in response to/according to a signal applied from the outside (e.g., from the controller and/or from one or more sensors as disclosed herein) to perform an opening or closing operation of a passage (e.g., between the one or more high pressure tanks and the fuel cell).

The controller may include, for example, a processor, a central processing unit (CPU), a microchip, a logic, an application-specific integrated circuit (ASIC), memory, etc. The controller may comprise one or more processors and a memory storing instructions that, when executed by the one or more processors perform one or more of the functions disclosed herein. Also, or alternatively, the controller may comprise and/or be communicatively connected to one or more sensors (e.g., pressure sensors, temperatures sensors), and may control the solenoid valve 313 by sending signals based on information detected by the one or more sensors (e.g., a pressure, a temperature, etc.). The controller may comprise an interface configured to receive input from one or more other controllers/the one or more sensors/a user. The signals, and/or sending of the signals, may be based on the input.

The pressure relief valve (TPRD) 314 may open in response to a high-temperature environment. The pressure of the high pressure tank 100 may be released, via the TPRD 314, when/if the temperature of the high pressure tank 100 satisfies (e.g., reaches or exceeds) a high-temperature upper limit.

The manual valve may block the fuel when/if the blocking function of the solenoid valve 313 is lost/fails. The manual valve may be manually and/or automatically controlled to block the fuel when/if the blocking function of the solenoid valve 313 is lost/fails.

The bleed valve may unblock the fuel when/if the unblocking function of the solenoid valve 313 is lost/fails. The discharge valve may be manually and/or automatically controlled to unblock the fuel when/if the unblocking function of the solenoid valve 313 is lost/fails. A discharge passage 317a, through which high-pressure hydrogen may be discharged, may be formed in the first valve housing part 310.

The manual valve and the bleed valve may be installed in a valve housing part as separate components to perform their respective functions. According to an example of the present disclosure, the integrated valve 317, in which the manual valve and the bleed valve are integrated, may be installed in the first valve housing part 310. A passage having a single operation direction of the integrated valve 317 may be disposed in the integrated valve 317 to be shared (e.g., by the manual valve and the bleed valve), and the discharge passage 317a, through which high-pressure hydrogen is discharged, may extend upward.

The integrated valve 317 may be/comprise a 3-way valve including operation directions of the manual valve and the bleed valve, and a discharge direction, in which the high-pressure hydrogen fuel of the bleed valve may be discharged (e.g., via the discharge passage 317a). In this way, the safety of an operator may be secured by separating the operation direction of the valve and the discharge direction of the hydrogen fuel.

The integrated valve 317 may be connected to the integrated passage 321. The integrated valve 317 may adjust a flow rate, through the integrated passage 321, of hydrogen to fill the one or more high pressure tanks 100 and/or of hydrogen to supply the fuel cell stack. The integrated valve 317 may control the flow rate by using/based on a pressure difference between the filling fuel stored in the high pressure tank 100 and the supply fuel supplied to the fuel cell stack.

### Second Valve Housing Part

The second valve housing part 320 (e.g., the second valve housing, the second part of the valve housing) may include a temperature sensor 322 that measures a temperature in the one or more high pressure tanks 100 (e.g., when/if the hydrogen fuel is filled in the high pressure tank 100) The second valve housing part 320 may include an excessive flow valve (EFV) 323 that controls supply and/or blocking of hydrogen (e.g., to the fuel cells) when/if an excessive amount of the hydrogen fuel is present in the first valve housing part 310.

A plurality of passages (e.g., four passages for hydrogen and/or communication passages may be disposed in the second valve housing part 320.

The second valve housing part 320 may be provided with an integrated passage 321, a flow rate control passage 324, and/or a temperature measurement communication passage 325.

The filling passage and the supply passage may be operated by one integrated passage 321.

The filling passage may be a passage through which the hydrogen fuel flows from the hydrogen inlet 311 to the one or more high pressure tanks 100 (e.g., when/if hydrogen is being filled to the one or more high pressure tanks 100). The supply passage may be a passage through which the hydrogen fuel flows from the high pressure tank 100 to the hydrogen outlet 312 (e.g., when hydrogen is being supplied from the one or more high pressure tanks 100 to the fuel cell stack).

The flow rate control passage 324 is a passage of/associated with the excessive flow valve 323, which controls the pressure of the hydrogen based on presence of an excessive amount of the hydrogen fuel in the first valve housing part 310.

The temperature measurement communication passage 325 may be a passage in which the temperature sensor 322 may be accommodated. The temperature sensor 322 may be configured to measure the temperature of the hydrogen fuel provided in an interior of the high pressure tank 100. The temperature measurement communication passage 325 may further accommodate one or more parts for protecting and/or connecting the temperature sensor 322 (e.g., to the controller, to the solenoid valve 313, etc.).

According to an example of the present disclosure, the container fixing block 200 may be connected to the valve assembly 300 by/via a single gas passage part. In contrast, some hydrogen fuel systems may require high pressure tanks to be connected to respective valves and via gas passage parts corresponding to the number of the high pressure tanks 100 installed. As such, the present disclosure reduces a number of parts, a weight of parts, and a cost of parts and assembly over such a technology,

According to an example of the present disclosure, a filling passage for filling the hydrogen fuel into the high pressure tank 100 and a supply passage for supplying the hydrogen fuel from the high pressure tank 100 may be constituted by/formed as a single integrated passage 321. By the integrated passage 321, the passage is simplified from two to one.

Furthermore, a single check valve 311a for preventing reverse flow of the hydrogen fuel during filling of the hydrogen fuel may be installed in the hydrogen inlet 311.

Check valves 311a may serve a function of preventing reverse flow of a receptacle with a hydrogen filling hole. The check valve 311a may be installed in each of the filling passages of the high-pressure hydrogen valve, the supply passages of the high-pressure hydrogen valve, the regulator, and the manifold, and the hydrogen inlet. but there are problems in terms of economic feasibility, such as an increase in weight and costs due to an increase in the number of parts.

According to the present disclosure, a single check valve 311a may be installed in the hydrogen inlet 311, without additional check valves installed in the valve assembly 300, thus reducing part number, weight and cost due to parts and assembly.

As an example, the valve assembly 300 may allow the high-pressure hydrogen fuel supplied from an external source to be filled in the interior of the high pressure tank 100, and may allow for supply the hydrogen fuel from the interior of the high pressure tank 100 to the fuel cell stack via the solenoid valve 313 and the regulator to allow electric energy to be produced in the fuel cell stack.

Referring to FIG. 2, in the valve assembly 300 according to an example of the present disclosure, the arrangement relationship between the solenoid valve 313, the integrated valve 317, the temperature-sensitive pressure relief valve (TPRD) 314, and the excessive flow valve 323 may be configured as follows.

The hydrogen inlet 311 and the solenoid valve 313 may be disposed in (e.g., extend through) a first side surface part 300a (e.g., a first side surface)of the valve assembly 300, the integrated valve 317 may be disposed in (e.g., extend through) a second side surface part 300b (e.g., a second side surface), and a pressure sensor 319 (e.g., configured to detect a high pressure and/or measure a pressure across the valve), the temperature-sensitive pressure relief valve (TPRD) 314, the regulator 315, and/or the pressure relief valve (PRV) 316 may be disposed in (e.g., extend through) a third side surface part 300c (e.g., a third side surface). The hydrogen outlet 312 may be provided at a position that is opposite to the hydrogen inlet 311 (e.g.,, may be disposed in a fourth side surface part 300d (e.g., a fourth side surface) across from to the first side surface part 300a).

For example, the excessive flow valve (EFV) 323 located in the second valve housing part 320 may be connected to the integrated valve 317 located in the first valve housing part 310 by/via the first passage 331 of an internal fluid path 330.

The hydrogen inlet 311 located in the first valve housing part 310 may be disposed to communicate with the integrated valve 317 located in the first valve housing part 310 by/via the second passage 332 of the internal fluid path 330. The solenoid valve 313 may be disposed to communicate with the regulator 315.

The integrated valve 317 may be mounted in a mounting hole formed in the second side surface part 300b. The temperature-sensitive pressure relief valve (TPRD) 314 may be mounted in a mounting hole formed in the third side surface part 300c. The second side surface part 300b and the third side surface part 300c may be opposite to each other and/or face each other. The mounting hole in the second side surface part 300b and the mounting hole in the third side surface part 300c may face each other and/or be positioned to align with each other.

The pressure relief valve (PRV) 316 may be mounted in a mounting hole located in and/or extending from the hydrogen outlet 312.

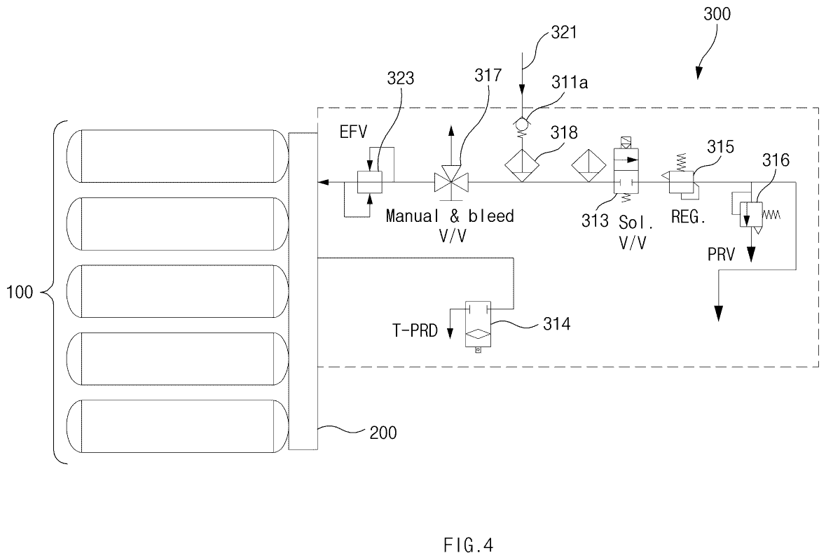

FIG. 4 is a circuit diagram illustrating an operation and control of a valve unit of the high pressure tank 100 according to an example of the present disclosure.

Referring to FIG. 4, in an example of the present disclosure, the valve assembly 300 for controlling filling and/or supplying the high-pressure hydrogen fuel may include a solenoid valve 313 that controls supply and/or blocking of the hydrogen fuel (e.g., in response to a control signal provided from an external source and/or based on a sensor), an integrated valve 317 (e.g., that controls a flow rate by using/based on a pressure difference of the filling fuel stored in the high pressure tank 100 and the supply fuel supplied to the fuel cell stack depending on whether the solenoid valve 313 breaks down), a regulator 315 (e.g., that reduces the pressure of the hydrogen fuel supplied from the high pressure tank 100 to an appropriate proper pressure, such as based on a pressure measurement and supplies the hydrogen fuel to the hydrogen outlet 312), and a pressure relief valve (PRV) 316 (e.g., that releases the pressure when/if the pressure of the outlet of the regulator 315 satisfies and/or is higher than a target pressure).

The valve assembly 300 may further include an excessive flow valve (EFV) 323 installed between the solenoid valve 313 and the integrated valve 317. When/if an excessive amount of the hydrogen fuel is present/detected (e.g., via a pressure sensor and/or temperature sensor, and/or a hydrogen gas sensor, etc.) between the solenoid valve 313 and the integrated valve 317, the excessive flow valve 323 may perform an operation of returning the discharged hydrogen to the high pressure tank 100 (or release the hydrogen from the first housing 310 and/or second housing 320) to reduce the amount of the discharged hydrogen when an operation flow rate is reached.

Furthermore, the integrated valve 317 may be installed between the solenoid valve 313 and the excessive flow valve 323. The hydrogen inlet 311 may be connected to the integrated passage 321 of the hydrogen fuel such that the hydrogen fuel may be provided via the hydrogen inlet 311 and the integrated passage 321 to fill the one or more high pressure tanks 100 via a common passage. The check valve 311a may be installed in the common passage of the hydrogen inlet 311 and the integrated passage 321.

The integrated valve 317 may have a filter 318 installed between the integrated valve 317 and the hydrogen inlet 311 of the valve assembly 300.

The temperature-sensitive pressure relief valve (TPRD) 314 may operate/respond to a temperature of the interior of the one or more high pressure tanks 100. For example, if a temperature of an interior of a high pressure tank 100 reaches a specific temperature, the temperature-sensitive pressure relief valve (TPRD) 314 may discharge the stored hydrogen fuel (e.g. to the outside for safety). The temperature sensor 322 may be provided in an interior of a temperature measurement communication passage 425 of the second valve housing part 320. The temperature sensor 322 may monitor temperature information (e.g., measure temperature values, detect when the temperature satisfies a threshold, such as meet or exceed a threshold temperature, etc.) of the hydrogen fuel stored in the one or more high pressure tanks 100.

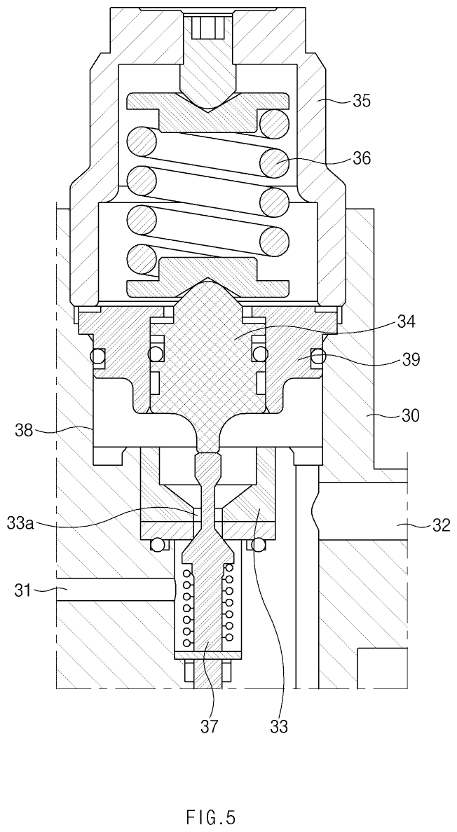

FIG. 5 is a cross-sectional view illustrating a regulator of a valve unit of a high pressure tank according to an example of the present disclosure.

According to an example of the present disclosure, the regulator 315 may include a housing 30, in which an inlet port 31 (e.g., through which high-pressure oxygen fuel may enter the regulator 315) and an outlet port 32 (e.g., through which the high-pressure hydrogen fuel may exit the regulator 315) are formed, and in which an orifice structure 33 (e.g., forming an orifice 33a configured to communicate the inlet port 31 and the outlet port 32) is formed. The regulator 315 may further comprise a first piston 34 (e.g., movably installed inside the housing 30, a cover 35 (configured to cover/close an opened upper side of the housing 30), and an elastic body 36 (e.g., a spring) interposed between the first piston 34 and the cover 35, and configured to transmit an elastic force to the first piston 34.

The orifice structure 33 may further comprise a valve body 37 that may be inserted into the orifice 33a to be movable to open and/or close the orifice 33a.

The first piston 34 may be installed in a pressure reduction chamber 38 in the interior of the housing 30. The pressure reduction chamber 38 may be configured to reduce the pressure of the high-pressure hydrogen fuel in the one or more high pressure tanks 100. For example, the first piston 34 may pressure/move the valve body 37 while being displaced upward or downward (e.g., by pressure of the hydrogen fuel introduced into an interior of the pressure reduction chamber 38). The valve body 37 may be pressured/moved to open the orifice 33a, thereby adjusting the pressure of the output hydrogen fuel to a set value.

A rear surface of the first piston 34 may be elastically supported by the elastic body 36. That is, the elastic body 36 may be installed to provide a restoring force to the first piston 34.

In the regulator 315 described herein, the high-pressure hydrogen fuel introduced through/via the inlet port 31 may be applied to the first piston 34 via the orifice 33a. The first piston 34 may be pressed (e.g., by the high-pressure hydrogen fuel introduced through/via the inlet port 31) when/if the pressure of the high-pressure hydrogen fuel is higher than a repulsive force of the elastic body 36. The valve body 37 may move in response to the first piston 34 moving, which may adjust an opening degree of the orifice 33a, thereby reducing the pressure.

As an example, the regulator 315 of the present disclosure may allow for using a first piston 34 having a smaller diameter than a piston in an existing regulator (e.g., smaller by about 50%, a 20 cm diameter in the present first piston 34 vs a 40 cm diameter of an existing regulator's piston). A smaller piston radius allows for a smaller total load on the elastic body 36, which results in an increased efficiency and reduced size of the elastic body 36.

Furthermore, the cover 35 has a function of finishing (e.g., closing) the opened upper side of the housing 30. Existing covers of regulators typically have an outer diameter that is formed to be larger than an outer diameter of the housing. However, the cover 35 according to an example of the present disclosure may have a reduced size as it has an outer diameter corresponding to the outer diameter of the housing 30, which is further reduced due to the reduced diameters of the first piston 34 and the elastic body 36.

Furthermore, a second piston 39 may guide an operation of the first piston 34. The second piston 39 may be provided at/around a circumference of the first piston 34. The second piston 39 may increase the efficiency of the elastic body 36 as well as guide the operation of the first piston 34.

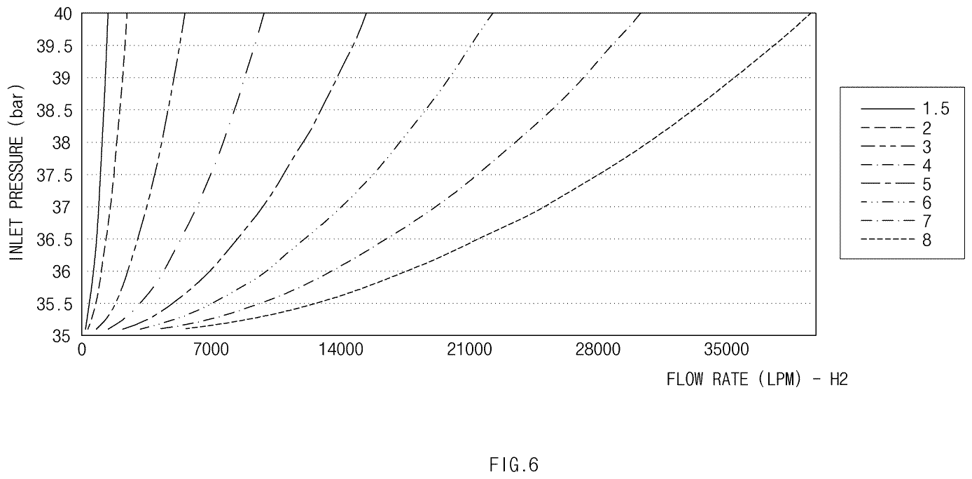

FIG. 6 is a graph depicting flow rates according to a diameter of a passage of a regulator according to an example of the present disclosure.

Referring to FIG. 6, based on the outlet pressure of 35 bar of the regulator 315, the flow rates of the passages for respective inlet pressures was calculated.

In the case of a target flow rate that satisfies a flow rate of 7000 LPM, which is a requirement of the hydrogen power vehicle, the target flow rate (7000 LPM) may be satisfied when the diameter of the passage is 4 mm or more at the inlet pressure of 38 bar.

The size of the passage may be determined depending on setting of a minimum pressure of the regulator 315 based on the graph of the flow rates for the respective input pressures of the regulator 315, and a flow rate loss safety rate for the filter may be selected.

The present disclosure provides a valve unit of a high pressure tank that may reduce costs while securing the airtightness of the container fixing block connected to the high pressure tank 100 and the valve assembly 300, and may increase economic feasibility by reducing weight and/or complexity.

The present disclosure provides a valve unit of a high pressure tank that may reduce costs while securing airtightness of a connection part connected to the high pressure tank and may increase economic feasibility by reducing weight.

The technical problems to be solved by the present disclosure are not limited to the aforementioned problems. Other technical problems will be clearly understood, from the present description, by those skilled in the art to which the present disclosure pertains.

According to the present disclosure, a valve unit includes a plurality of high pressure tanks each including a nozzle part, from which a hydrogen fuel is discharged, a container fixing block connected to the nozzle part, and including a gas passage part, in which the hydrogen fuel discharged from the nozzle part flows, in an interior space thereof, and a valve assembly connected to the gas passage part of the container fixing block, and including an internal fluid path, to which a plurality of valves are connected, in an interior thereof.

According to an example of the present disclosure, the valve assembly may include a hydrogen inlet/outlet, a solenoid valve that controls supply and blocking of the hydrogen fuel through the hydrogen inlet/outlet, a temperature-sensitive pressure relief valve (TPRD) that releases a pressure when the hydrogen fuel reaches a high-temperature/high-pressure upper limit, a regulator that regulates the hydrogen fuel supplied from the high pressure tank to an appropriate pressure, and a first valve housing part including a pressure relief valve (PRV) that releases the pressure when a pressure of an outlet of the regulator is higher than a target pressure.

According to an example of the present disclosure, the first valve housing part may further include an integrated valve, in which a manual valve manually operated when a blocking function of the solenoid valve is lost, and a bleed valve manually operated when an unblocking function for the solenoid valve is lost are integrated.

According to an example of the present disclosure, the valve assembly may include a second valve housing part including a temperature sensor that measures a temperature in the tank when the hydrogen fuel is filled in the high pressure tank, and an excessive flow valve (EFV) that controls supply and blocking of hydrogen when an excessive amount of the hydrogen fuel is present in the first valve housing part.

According to an example of the present disclosure, the second valve housing part may include an integrated passage, in which a filling passage for filling the hydrogen fuel in the high pressure tank and a supply passage for supplying the hydrogen fuel from the high pressure tank are integrated, a flow rate control passage for controlling a pressure of hydrogen when an excessive amount of the hydrogen fuel is present in the first valve housing part, and a temperature measurement communication passage for measuring a temperature of the hydrogen fuel in an interior of the high pressure tank.

According to an example of the present disclosure, a passage having a single operation direction of the internal fluid path may be disposed in the integrated valve, and the integrated valve may include a discharge passage, through which the high-pressure hydrogen fuel is discharged upward.

According to an example of the present disclosure, the integrated valve may include a 3-way valve having an operation direction and a discharge direction, in which the high-pressure hydrogen is discharged.

According to an example of the present disclosure, in the hydrogen inlet, a single check valve may be installed in a common passage with the integrated passage.

According to an example of the present disclosure, the regulator may include a housing including an inlet/outlet port of the hydrogen fuel, an orifice structure installed in an interior of the housing, a valve body installed in the orifice structure, and that opens and closes the orifice, a piston pressed by the valve body, an elastic body installed to provide a restoring force to the piston, and a cover finishing an opened upper side of the housing, and having an outer diameter corresponding to an outer diameter of the housing.

According to an example of the present disclosure, the piston may include a first piston installed inside the housing, and that is elevated, and a second piston installed at a circumference of the first piston, and that guides an operation of the first piston.

According to an example of the present disclosure, a filter that prevents introduction of foreign substances when the hydrogen fuel is filled may be provided on a rear side of the check valve.

According to the valve unit of the high pressure thank according to the present disclosure having the above-described configuration, the number of parts may be reduced by integrating the valve, the regulator, the manifold, and the pipe as one system, and a leakage problem due to that may be solved.

The number of check valves may be reduced by simplifying the filling passage, and the supply passage.

The number of parts may be reduced by integrating the structures of the manual valve and the bleed valve into one to perform the functions of two valves in one integrated valve.

The diameter of the piston may be reduced by reducing the diameter of the cover of the regulator and forming the piston in a dual structure, and thus, may increase the efficiency of the spring.

The above-mentioned description of the present disclosure is intended to be illustrative, and it should be understood by those skilled in the art that the present disclosure may be embodied in other specific forms without departing from the spirit or essential characteristics thereof. Therefore, the above-described examples are examples in all aspects, and should be construed not to be restrictive. The scope of the present disclosure is defined by claims to be described below, and it should be interpreted that the scopes or claims of the present disclosure and all modifications or changed forms derived from the equivalent concept are included in the scopes of the present disclosure.

What is claimed is:

1. A valve assembly comprising:
a hydrogen fuel inlet;
a hydrogen fuel outlet;
a solenoid valve configured to control flow of a hydrogen fuel, supplied from or filled to a plurality of high pressure tanks, through the hydrogen fuel inlet or the hydrogen fuel outlet;
a first pressure relief valve configured to release a pressure based on the hydrogen fuel satisfying one or more of:
a high-temperature limit; or
a high-pressure upper limit;
a regulator configured to regulate a pressure of the hydrogen fuel being supplied from the plurality of high pressure tanks; and
a first valve housing comprising a second pressure relief valve configured to release a pressure when a pressure of an outlet of the regulator is higher than a target pressure,
wherein the valve assembly forms an internal fluid path between the hydrogen fuel inlet and the hydrogen fuel outlet.

2. The valve assembly of claim 1, wherein the first valve housing further comprises an integrated valve comprising:
a manual valve configured to be operated based on failure of a blocking function of the solenoid valve; and
a bleed valve configured to be operated based on failure of an unblocking function of the solenoid valve.

3. The valve assembly of claim 2, wherein the integrated valve comprises a passage having a single operation direction of the internal fluid path, and
wherein the integrated valve comprises a discharge passage configured to allow discharge of the hydrogen fuel.

4. The valve assembly of claim 3, wherein the integrated valve comprises a 3-way valve having an operation direction of the manual valve and the bleed valve and a discharge direction in which the hydrogen fuel is discharged to the discharge passage.

5. The valve assembly of claim 1, wherein the valve assembly comprises a second valve housing comprising:
a temperature sensor configured to measure a temperature in a high pressure tank of the plurality of high pressure tanks; and
an excessive flow valve configured to control, based on an amount of the hydrogen fuel present in the first valve housing, supply or blocking of the hydrogen fuel from the plurality of high pressure tanks.

6. The valve assembly of claim 5, wherein the second valve housing comprises:
an integrated passage, in which a filling passage for filling the hydrogen fuel into the plurality of high pressure tanks and a supply passage for supplying the hydrogen fuel from the plurality of high pressure tanks are integrated;
a flow rate control passage configured to, based on an amount of the hydrogen fuel present in the first valve housing, control a pressure of the hydrogen fuel in the integrated passage; and
a temperature measurement communication passage configured to accommodate the temperature sensor for measuring a temperature of the hydrogen fuel in an interior of the high pressure tank.

7. The valve assembly of claim 6, wherein a single check valve is installed in a common passage, of the hydrogen fuel inlet, common with the integrated passage.

8. The valve assembly of claim 7, further comprising a filter, configured to filter foreign substances from hydrogen fuel entering the hydrogen fuel inlet, provided on a rear side of the single check valve relative to an entrance of the hydrogen fuel inlet.

9. The valve assembly of claim 1, wherein the regulator comprises:
a housing comprising:
an inlet port of the hydrogen fuel; and
an outlet port of the hydrogen fuel;
an orifice structure, installed in an interior of the housing, forming an orifice;
a valve body installed in the orifice structure, and configured to open and close the orifice;
a piston in contact with and configured to be pressed by the valve body;
an elastic body configured to provide a restoring force to the piston; and
a cover configured to close an opened upper side of the housing, and having an outer diameter corresponding to an outer diameter of the housing.

10. The valve assembly of claim 9, wherein the piston comprises:
a first piston; and
a second piston installed at a circumference of the first piston, and configured to guide an operation of the first piston.

11. A high pressure tank connection system comprising:
a plurality of high pressure tanks, each comprising a nozzle configured to discharge a hydrogen fuel;
a container fixing block configured to accommodate the plurality of high pressure tanks and comprising a gas passage, in which the hydrogen fuel discharged from the nozzle flows, in an interior space thereof; and
a valve assembly, connected to the gas passage, forming an internal fluid path, and comprising a plurality of valves configured to control a flow of hydrogen fuel through the internal fluid path.

12. The high pressure tank connection system of claim 11, wherein the valve assembly comprises:
a hydrogen fuel inlet;
a hydrogen fuel outlet;
a solenoid valve configured to control flow of the hydrogen fuel through the hydrogen fuel inlet or the hydrogen fuel outlet;
a first pressure relief valve configured to release a pressure based on the hydrogen fuel satisfying one or more of:
a high-temperature limit; or
a high-pressure upper limit;
a regulator configured to regulate a pressure of the hydrogen fuel supplied from the plurality of high pressure tanks; and
a first valve housing comprising:
a second pressure relief valve configured to release the pressure when a pressure of an outlet of the regulator is higher than a target pressure.

13. The high pressure tank connection system of claim 12, wherein the first valve housing further comprises an integrated valve comprising:
a manual valve configured to be operated based on failure of a blocking function of the solenoid valve; and
a bleed valve configured to be operated based on failure of an unblocking function of the solenoid valve.

14. The high pressure tank connection system of claim 13, wherein the integrated valve comprises a passage having a single operation direction of the internal fluid path, and
wherein the integrated valve comprises a discharge passage configured to allow discharge of the hydrogen fuel.

15. The high pressure tank connection system of claim 14, wherein the integrated valve comprises a 3-way valve having an operation direction of the manual valve and the bleed valve and a discharge direction in which the hydrogen fuel is discharged to the discharge passage.

16. The high pressure tank connection system of claim 12, wherein the valve assembly comprises a second valve housing comprising:
a temperature sensor configured to measure a temperature in a high pressure tank of the plurality of high pressure tanks; and
an excessive flow valve configured to control, based on an amount of the hydrogen fuel present in the first valve housing. supply or blocking of the hydrogen fuel from the plurality of high pressure tanks.

17. The high pressure tank connection system of claim 16, wherein the second valve housing comprises:
an integrated passage, in which a filling passage for filling the hydrogen fuel into the plurality of high pressure tanks and a supply passage for supplying the hydrogen fuel from the plurality of high pressure tanks are integrated;
a flow rate control passage configured to, based on an amount of the hydrogen fuel present in the first valve housing, control a pressure of the hydrogen fuel in the integrated passage; and
a temperature measurement communication passage configured to accommodate the temperature sensor for measuring a temperature of the hydrogen fuel in an interior of the high pressure tank.

18. The high pressure tank connection system of claim 17, wherein a single check valve is installed in a common passage, of the hydrogen fuel inlet, common with the integrated passage.

19. The high pressure tank connection system of claim 18, further comprising a filter, configured to filter foreign substances from hydrogen fuel entering the hydrogen fuel inlet, provided on a rear side of the single check valve relative to an entrance of the hydrogen fuel inlet.

20. The high pressure tank connection system of claim 12, wherein the regulator comprises:
a housing comprising:
an inlet port of the hydrogen fuel; and
an outlet port of the hydrogen fuel;
an orifice structure, installed in an interior of the housing, forming an orifice;
a valve body installed in the orifice structure, and configured to open and close the orifice;
a piston in contact with and configured to be pressed by the valve body;
an elastic body configured to provide a restoring force to the piston; and
a cover configured to close an opened upper side of the housing, and having an outer diameter corresponding to an outer diameter of the housing.
